(19) United States
(12) Patent Application Publication
(10) Pub. No.: US 2024/0328874 A1
(43) Pub. Date: Oct. 3, 2024

(54) STRESS-COMPENSATED WHEATSTONE HEATER AND THERMOMETER IN RESISTIVE MICROELECTROMECHANICAL SYSTEM PRESSURE SENSORS

(71) Applicant: Apple Inc., Cupertino, CA (US)

(72) Inventors: Matthias IKEDA, Cupertino, CA (US); Gregory B. ARNDT, San Jose, CA (US); Richard YEH, Los Altos, CA (US)

(21) Appl. No.: 18/545,650

(22) Filed: Dec. 19, 2023

Related U.S. Application Data
(60) Provisional application No. 63/456,399, filed on Mar. 31, 2023.

(51) Int. Cl. G01L 1/22

(52) U.S. Cl. CPC G01L 1/2281

(57) ABSTRACT

An apparatus of the subject technology includes a membrane, a first circuit and a second circuit. The first circuit includes a number of resistive elements disposed on the membrane to measure a pressure difference. The first circuit has a resistance. The second circuit implements a temperature calibration procedure by utilizing the resistance to measure a temperature used in the temperature calibration procedure.

### CROSS-REFERENCE TO RELATED APPLICATION(S)

This application claims the benefit of U.S. Provisional Application Ser. No. 63/456,399, entitled “STRESS-COMPENSATED WHEATSTONE HEATER AND THERMOMETER IN RESISTIVE MICROELECTROMECHANICAL SYSTEM PRESSURE SENSORS,” and filed on Mar. 31, 2023, the disclosure of which is expressly incorporated by reference herein in its entirety.

### TECHNICAL FIELD

The present description relates generally to electronic devices, for example, to a stress-compensated Wheatstone heater and thermometer in resistive microelectromechanical system (MEMS) pressure sensors.

### BACKGROUND

Resistive MEMS pressure sensors typically make use of a Wheatstone bridge architecture fabricated on top of a thin silicon substrate. In many state-of-the-art resistive MEMS pressure sensors, a dedicated temperature sensor is implemented on the application-specific integrated circuit (ASIC) chip used for signal processing. The temperature sensor on the ASIC chip can then be used to estimate the substrate temperature of the MEMS chip to allow temperature calibration.

One of the limitations of this technique is that temperature offsets occurring between the temperature sensor and the Wheatstone bridge introduce calibration errors. Under non-static conditions, these offsets further occur with a time delay corresponding to the characteristic time constant of thermalization of the ASIC and MEMS chip. This limitation, among others, necessitates an industry need for better MEMS pressure sensors.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 is a high-level diagram illustrating an example of an apparatus having a stress-compensated Wheatstone heater and thermometer, according to one or more implementations of the subject technology.

FIGS. 2A and 2B are schematic diagrams illustrating a top view and a cross-sectional view of an example implementation of the apparatus of FIG. 1, according to one or more implementations of the subject technology.

FIG. 3 is a diagram illustrating an example of a Wheatstone bridge showing the temperature dependency of a resistance of the bridge.

FIG. 4 is a flow diagram illustrating an example of a method for implementing a calibration procedure, according to one or more implementations of the subject technology.

FIG. 5 is a schematic diagram illustrating an example of an electronic device within which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

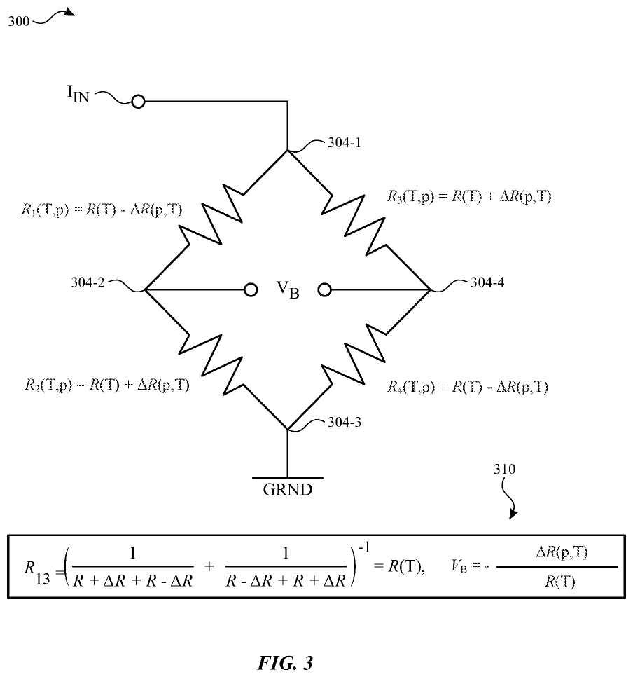

In some aspects, the subject technology is directed to a stress-compensated Wheatstone heater and thermometer in resistive MEMS pressure sensors. The subject disclosure uses the Wheatstone bridge resistance to measure the MEMS substrate (membrane) temperature in addition to the use of the Wheatstone bridge as a pressure sensor. The total bridge resistance can be designed to be independent of strain so long as the strain fields are the result of a homogeneously distributed force (e.g., a force on a MEMS substrate due to a pressure difference between two surfaces of the substrate, such as the front surface and the back surface). The resistance of the bridge shown in the FIG. 3 is equal to R, which is a function of temperature but is independent of applied stress. It can thus serve as a stress-compensated temperature sensor. The temperature dependence is adjusted by the doping level chosen for the fabrication of the bridge resistors but is typically tuned to the metallic regime, where the resistance varies linearly with temperature.

Furthermore, the disclosed technology uses Wheatstone bridge simultaneously as a heater element, which allows the substrate temperature to change and enable rapid pressure sensor calibration. In some embodiments, two similar Wheatstone bridges can be implemented on the same membrane, one for the pressure measurement and another one for the temperature measurement and heating. Thus, simultaneous detection of the bridge resistance allows for rapid and accurate pressure sensor calibration. This calibration procedure can be performed pre and post soldering of the pressure sensor to its board inside the device. Due to the fast thermalization times of the MEMS substrate, the disclosed technique may mitigate or avoid systematic errors due to incorrect temperature estimations and potentially reduce the testing time for thermal tests of the pressure sensor in the factory, in some instances, by at least two orders of magnitude.

The subject technology improves upon the existing technique by reducing or fully circumventing limitations of the existing technique, for example, by measuring the temperature directly on the MEMS substrate. Current techniques also face the challenge of being sensitive to strain due to the elastoresistivity of any single resistive temperature sensor on the substrate. To solve this issue, the subject technology uses the Wheatstone bridge resistance as a measure for the MEMS substrate temperature, as mentioned above, and will be discussed in more details herein.

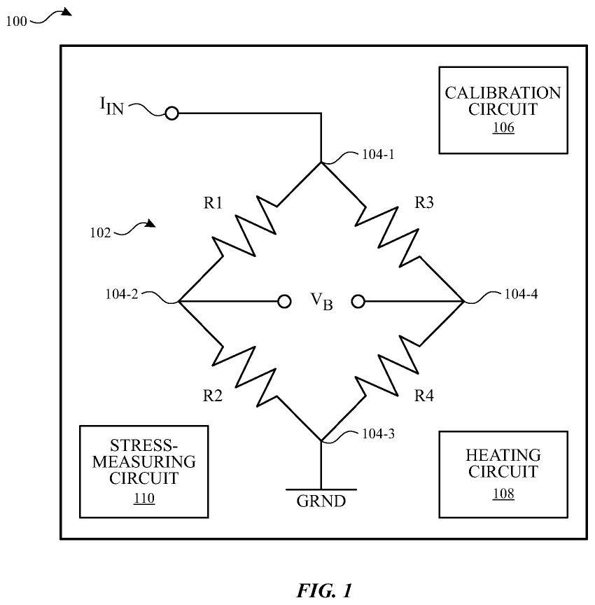

FIG. 1 is a high-level diagram illustrating an example of an apparatus 100 having a stress-compensated Wheatstone heater and thermometer, according to one or more implementations of the subject technology. The apparatus 100 includes a first circuit 102, a second circuit 106, a third circuit 108 and a fourth circuit 110. In some embodiments, the first circuit 102 is a stress-compensated Wheatstone heater and thermometer including elements (resistive elements) represented by resistances R1, R2, R3 and R4 and connected to nodes 104 (104-1, 104-2, 104-3 and 104-4), as shown in FIG. 1. The node 104-1 is coupled to an input current I_{IN}, and the node 104-3 is connected to the ground potential (GRND). The resistive elements are placed on a membrane such that the resistors experience a change in their value ±ΔR as a response to a given pressure difference. The bridge voltage V_{B} measured between nodes 104-2 and 104-4 is then proportional to ΔR and thus measurement of V_{B} allows for calculation of the pressure difference experienced by the membrane.

The second circuit 106 is a calibration circuit and can implement a temperature-calibration procedure by utilize the resistance of the bridge as seen from the nodes 104-1 and 104-3 to measure a temperature used in the temperature-calibration procedure. Existing solutions use a separate thermometer for temperature calibration, which introduces a number of errors as explained above. As both, the elastoresistivity, (dρ/dε)_{T}, and the resistivity p of the resistive elements (R1, R2, R3 and R4) are temperature dependent, the calibration procedure of the subject disclosure calibrates these quantities as a function of temperature. The resistance of the bridge as seen from the nodes 104-1 and 104-3 is independent of the strain caused by the pressure difference.

In some embodiments, the third circuit 108 includes a heating circuit that includes, for example, logic and circuitry that can control a level of the input current I_{IN} applied to the first circuit 102 to cause a temperature change of the resistive elements (R1, R2, R3 and R4). The resistance of the first circuit 102 can be measured through measuring the voltage V₁₃ across nodes 104-1 and 104-3, which can be used to measure the temperature. Estimations using a one-dimensional (1-D) heat flow model indicate that a relatively moderate power on the order of about 1 Watt induced through Joule heating is sufficient to warm up the MEMS substrate by 35 degrees, covering a useful temperature window for sensor calibration. It is noted that with a typical resistance (e.g., about 1 kΩ) of the resistive elements, a current of about 1 mA can produce a heat power of about 1 Watt and a voltage V₁₃ of about 1V. In addition, the small heat capacity of the membrane material (e.g., silicon) together with its large thermal conductivity results in a fast time constant of thermalization for the MEMS substrate. This allows for rapid temperature cycling of the MEMS substrate using the Wheatstone bridge as a heating element.

In some embodiments, the fourth circuit 110 is a stress-measuring circuit and includes circuitry to determine the stress applied to the membrane by measuring the bridge voltage across the terminals 104-2 and 104-4 of the first circuit 102.

In some embodiments, the second circuit 106 uses the temperature-calibration procedure to allow measuring the pressure difference independent of a temperature change. In some embodiments, the second circuit 106 can implement the temperature-calibration procedure by: a) varying a temperature of the membrane using the third circuit 108 (heating circuit) at a predetermined pressure while simultaneously measuring the resistance (e.g., between nodes 104-1 and 104-3) through the voltage V₁₃ of the first circuit 102; and b) measuring the stress applied to the membrane using the fourth circuit 110. That is, an embodiment of the subject technology can use the Wheatstone bridge resistors as heating elements, instead of using a separate resistor created on the MEMS, as used by the existing solution. In some embodiments, two similar Wheatstone bridges can be created on the membrane. One of the Wheatstone bridges can be used for measuring pressure difference, and the other one for measuring temperature and providing heating.

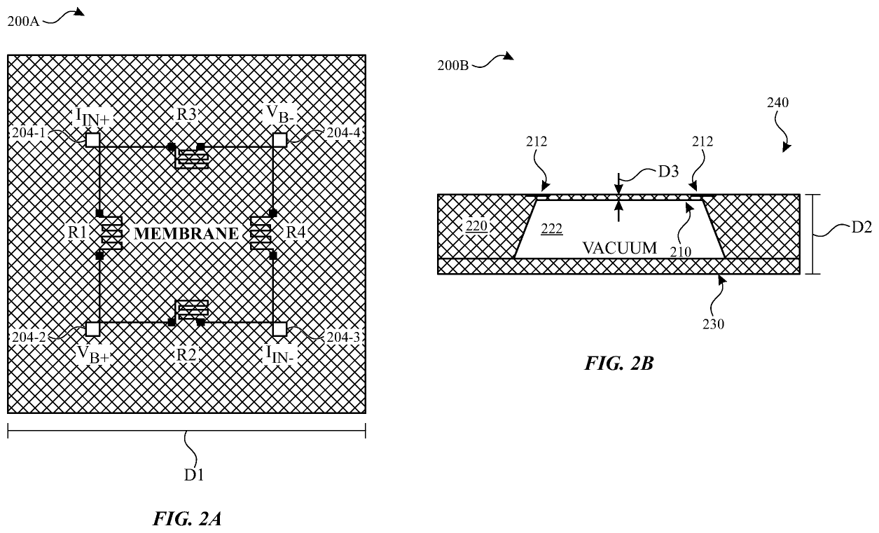

FIGS. 2A and 2B are schematic diagrams illustrating a top view 200A and a cross-sectional view 200B of an example implementation of the apparatus 100 of FIG. 1, according to one or more implementations of the subject technology. The top view 200A shows the membrane 210 on which the resistive elements of the first circuit (102 of FIG. 1) represented by R1, R2, R3 and R4 are disposed. In some embodiments, the membrane 210 is a MEMS membrane and can be made of a material including, but not limited to, a semiconductor material, for example, silicon. The membrane 210 can be a thin layer, for example, with a thickness of less than about 8 μm. In some embodiments, a width D1 of the membrane 210 can be less than about 2 mm (e.g., 1.5 mm).

The resistive elements (R1, R2, R3 and R4) are made of an electrically conductive material including, but not limited to, metals and metal oxides for example, carbon and silicon. In some embodiments, a diffused semiconductor layer (e.g., p-type diffused into an n-type wafer) can be produced, for example, by ion implantation. The resistive elements (R1, R2, R3 and R4) are connected to one another at nodes 204 (204-1, 204-2, 204-3 and 204-4). The node 204-1 and 204-3 are respectively connected to an input current source providing supply currents (e.g., Iᵢₙ₊ and Iᵢₙ₋). This source can be provided, for example, the third circuit 108 of FIG. 1 (heating circuit) to control heat generation by the resistive elements. The nodes 204-1 and 204-3 form a voltage output port of the first circuit 102, which can be read to determine the temperature-dependent resistance of the first circuit 102. The nodes 204-2 and 204-4 form another voltage output port of the first circuit 102, which can be read to determine the stress-dependent bridge voltage V_{B} of the first circuit 102.

The cross-sectional view 200B shows the membrane 210 with a thickness D3 (e.g., about 8 μm) created, for example, by forming a cavity 222 in a silicon wafer 220. The cavity 222 can be formed by using a semiconductor process, for example, by an etch process. The silicon wafer 220 is attached to a substrate 230 to form the MEMS 240. A thickness D2 of the MEMS 240 can be about 350 μm. The cross-sectional of the resistive elements of the Wheatstone bridge (first circuit 102) are shown in the cross-sectional view 200B as lines 212.

In some embodiments, the silicon wafer 220 may be used with other circuitry, for example, the second circuit 106 and the third circuit 108 of FIG. 1 and one or more processors, which can be implemented on the ASIC chip.

FIG. 3 is a diagram illustrating an example of a Wheatstone bridge 300 showing the temperature dependency of a resistance of the bridge. The resistors R1, R2, R3 and R4 of the Wheatstone bridge 300 are connected to nodes 304-1, 304-2, 304-3 and 304-4. The nodes 304-1 and 304-3 are respectively connected to the input current I_{IN} and the ground potential (GRND). The nodes 304-2 and 304-4 form the output port of the Wheatstone bridge 300 and can be used to read an output voltage (V_{B}), which measures the stress applied to the membrane. The resistance R(T) of the Wheatstone bridge can be read by measuring the voltage across the nodes 304-1 and 304-3 of the Wheatstone bridge 300.

As a force (pressure) is applied to the membrane 210 of FIG. 2A, due to a pressure difference on two sides of the membrane, each of the bridge resistors may experience an individual strain field, denoted by εᵢ due to the deformation of the MEMS membrane 210 and hence change their resistance values according to the elastoresistivity (dρ/dεₜ)_{T}. In some aspects, the strain field is different for each bridge resistor. In other aspects, the strain magnitude may be identical for all bridge resistors while the sign varies between each pair of opposing resistors (e.g., R1/R3 and R2/R4). Additionally, the resistivity p, a temperature dependent property of the resistive material, changes due to the pressure differences. The placement of the resistors (R1, R2, R3 and R4) onto the membrane 210 can be chosen such that the resistors experience a change in their value ±ΔR as a response to a given pressure difference. The bridge output voltage V_{B} is then proportional to ΔR(p,T)/R(T). Temperature calibration then allows to extract the stress-dependent change independent of temperature. Together with temperature calibration, the measurement of V_{B} allows for determining the pressure difference experienced by the membrane independent of the temperature.

The resistance R(T) of the Wheatstone bridge 300 as seen from the output port (nodes 304-1 and 304-3), as shown by the expression 310 is independent of AR and only varies with temperature T. In the expression 310, R represents the resistance of the resistors (R1, R2, R3 and R4), when the membrane is at rest (e.g., no pressure is applied to the membrane) and can be about 1 kΩ.

As the elastoresistivity and the resistivity of the bridge resistors are temperature dependent, the calibration of these quantities as a function of temperature can be achieved by the thermal-calibration procedure of the subject technology, which is performed by the second circuit 106 of FIG. 1. The method of implementing the calibration procedure is further described below.

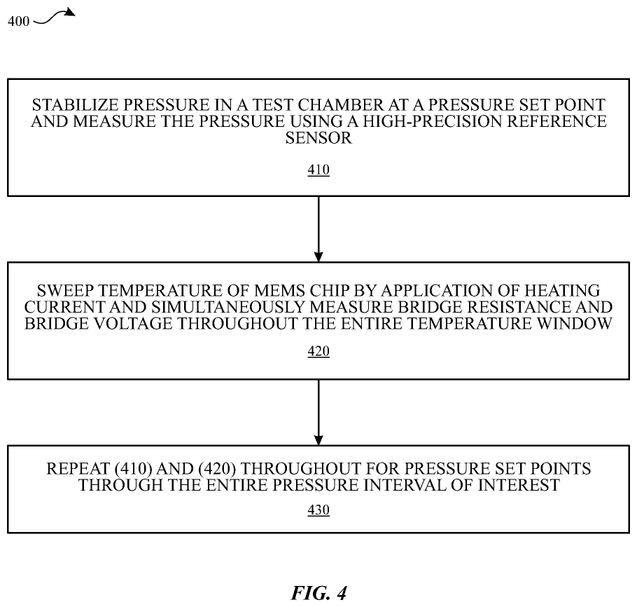

FIG. 4 is a flow diagram illustrating an example of a method 400 for implementing a calibration procedure, according to one or more implementations of the subject technology. The calibration procedure can be implemented by the second circuit 106, the third circuit 108 and the fourth circuit 110 of FIG. 1. In some embodiments, the calibration can be performed in a factory. In some embodiments, the temperature re-calibration could also be performed at ambient pressure in the field using the method 400 but skipping the step 410. Using the apparatus (e.g., 100 of FIG. 1) of the subject technology and the disclosed calibration procedure, the testing time for the calibration procedure can be reduced by at least 2 orders of magnitude, for example, from 300 seconds (5 minutes) to about 3 seconds. The MEMS Wheatstone bridge of the subject technology is expected to have a fast thermalization (e.g., on the order of about 50 milli-seconds (ms)). As a reference, the thermalization time of a multilayer board (MLB) in a device such as a tablet or a smartphone is on the order of about 10-100 s.

In general, a calibration uses the measured sensor output at known pressure and temperature. As indicated above, both the temperature gradients and pressure gradients can lead to calibration errors and may be avoided. Compared to temperature, it is relatively straight forward to apply a systemwide (within a test chamber) homogeneous pressure and measure it using a reference sensor at a location inside the test chamber. Large pressure gradients leading to calibration errors can be avoided by designing the setup with appropriate geometry and making sure the sealing components are working to specification. Since for the disclosed calibration procedure, the temperature measurement is performed using the pressure sensing elements, errors due to temperature gradients are mitigated or even avoided. Since the thermalization time (e.g., characterized by a thermal constant) of the MEMS Wheatstone bridge is small, the calibration procedure can be relatively short (e.g., about 3 s), as compared to using a separate resistor on the chip for temperature calibration.

The method 400 begins with stabilizing the pressure in a test chamber at a first pressure (setpoint) and measure the pressure using a high-precision reference sensor (410). Sweep temperature of the MEMS chip (e.g., the apparatus 100 of FIG. 1) by application (e.g., using the third circuit 108 of FIG. 1) of a heating current (e.g., of the order of 1 mA) and simultaneously measuring the bridge resistance (at nodes 204-1 and 204-3 of FIG. 2A) and bridge voltage (e.g., V_{B} of FIG. 1) throughout the entire temperature window (e.g., 25° C. to 60° C.) (420). Next, the steps (410) and (420) are repeated throughout for pressure setpoints through the entire pressure interval of interest (e.g., 30 to 110 KPa) (430).

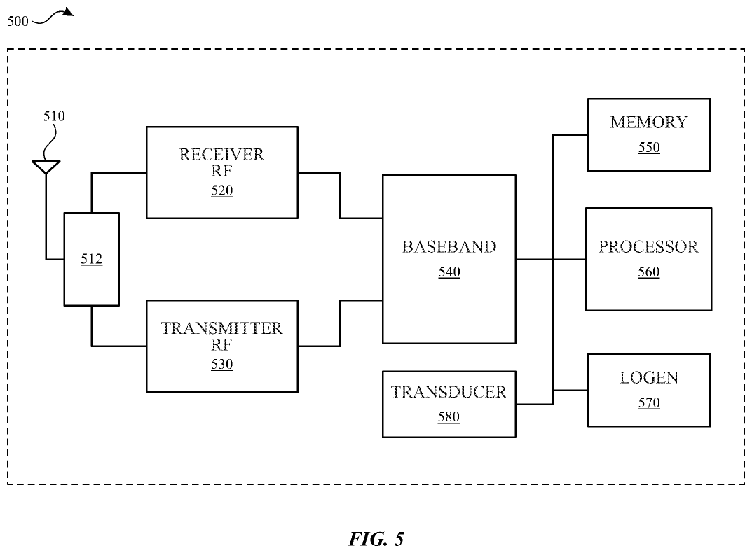

FIG. 5 is a schematic diagram illustrating an example of an electronic device within which aspects of the subject technology may be implemented. In some aspects, the electronic device 500 may represent a mobile communication device (e.g., a smartphone or smartwatch), a tablet, a laptop or any other electronic device. The electronic device 500 may comprise a radio frequency (RF) antenna 510, a receiver 520, a transmitter 530, a baseband processing module 540, a memory 550, a processor 560, a local oscillator generator (LOGEN) 570 and a transducer 580. In various embodiments of the subject technology, one or more of the blocks represented in FIG. 5 may be integrated on one or more semiconductor substrates. The blocks 520-570, for example, may be realized on a single chip, a single system on a chip or on a multi-chip chipset.

The RF antenna 510 may be suitable for transmitting and/or receiving RF signals (e.g., wireless signals) over a wide range of frequencies. Although a single RF antenna 510 is illustrated, the subject technology is not so limited.

The receiver 520 may comprise suitable logic circuitry and/or code that may be operable to receive and process signals from the RF antenna 510. The receiver 520 may, for example, be operable to amplify and/or down-convert received wireless signals. In various embodiments of the subject technology, the receiver 520 may be operable to cancel noise in received signals and may be linear over a wide range of frequencies. In this manner, the receiver 520 may be suitable for receiving signals in accordance with a variety of wireless standards, including Wi-Fi, WiMAX, Bluetooth and other various cellular standards. In various embodiments of the subject technology, the receiver 520 may not require any SAW filters and few or no off-chip discrete components, such as large capacitors and inductors.

The transmitter 530 may comprise suitable logic circuitry and/or code that may be operable to process and transmit signals from the RF antenna 510. The transmitter 530 may, for example, be operable to up-convert baseband signals to RF signals and amplify RF signals. In various embodiments of the subject technology, the transmitter 530 may be operable to up-convert and amplify baseband signals processed in accordance with a variety of wireless standards. Examples of such standards may include Wi-Fi, WiMAX, Bluetooth and other various cellular standards. In various embodiments of the subject technology, the transmitter 530 may be operable to provide signals for further amplification by one or more power amplifiers.

The duplexer 512 may provide isolation in the transmit band to avoid saturation of the receiver 520, damaging parts of the receiver 520 and/or to relax one or more design requirements of the receiver 520. Furthermore, the duplexer 512 may attenuate the noise in the receive band. The duplexer may be operable in multiple frequency bands for various wireless standards.

The baseband processing module 540 may comprise suitable logic, circuitry, interfaces and/or code that may be operable to perform processing of baseband signals. The baseband processing module 540 may, for example, analyze received signals, generate control and/or feedback signals for configuring various components of the electronic device 500, such as the receiver 520. The baseband processing module 540 may be operable to encode, decode, transcode, modulate, demodulate, encrypt, decrypt, scramble, descramble and/or otherwise process data in accordance with one or more wireless standards. In some implementations, the baseband processing module 540 may include an intelligent boot circuit and perform the functionalities of the intelligent boot of the subject technology, as described above.

The processor 560 may comprise suitable logic, circuitry and/or code that may enable processing data and/or controlling operations of the electronic device 500. In this regard, the processor 560 may be enabled to provide control signals to various other portions of the electronic device 500. The processor 560 may also control transfers of data between various portions of the electronic device 500. Additionally, the processor 560 may enable the implementation of an operating system or otherwise execute code to manage the operations of the electronic device 500.

The memory 550 may comprise suitable logic, circuitry and/or code that may enable the storage of various types of information, such as received data, generated data, code and/or configuration information. The memory 550 may comprise, for example, RAM, ROM, flash and/or magnetic storage. In various embodiments of the subject technology, information stored in the memory 550 may be utilized for configuring the receiver 520 and/or the baseband processing module 540.

The local oscillator generator (LOGEN) 570 may comprise suitable logic, circuitry, interfaces and/or code that may be operable to generate one or more oscillating signals of one or more frequencies. The LOGEN 570 may be operable to generate digital and/or analog signals. In this manner, the LOGEN 570 may be operable to generate one or more clock signals and/or sinusoidal signals. Characteristics of the oscillating signals, such as the frequency and the duty cycle, may be determined based on one or more control signals from, for example, the processor 560 and/or the baseband processing module 540.

In operation, the processor 560 may configure the various components of the electronic device 500 based on a wireless standard according to which it is desired to receive signals. Wireless signals may be received via the RF antenna 510 and amplified and down converted by the receiver 520. The baseband processing module 540 may perform noise estimation and/or noise cancellation, decoding and/or demodulation of the baseband signals. In this manner, information in the received signal may be recovered and utilized appropriately. For example, the information may be audio and/or video to be presented to a user of the electronic device, data to be stored in the memory 550 and/or information affecting and/or enabling the operation of the electronic device 500. The baseband processing module 540 may modulate, encode and perform other processing on audio, video and/or control signals to be transmitted by the transmitter 530 in accordance with various wireless standards.

In some implementations, the transducer 580 may be a pressure sensor of the subject technology (e.g., a MEMS pressure sensor) that includes a stress-compensated Wheatstone-bridge heater and thermometer, as described above, with respect to FIGS. 1, 2A, 2B and 3. This allows utilizing the resistors of the Wheatstone bridge to heat the pressure sensor for temperature calibration and avoid using an auxiliary resistor on the MEMS chip for the heating purpose.

As used herein, the phrase “at least one of” preceding a series of items, with the terms “and” or “or” to separate any of the items, modifies the list as a whole rather than each member of the list (i.e., each item). The phrase “at least one of” does not require selection of at least one of each item listed; rather, the phrase allows a meaning that includes at least one of any one of the items and/or at least one of any combination of the items and/or at least one of each of the items. By way of example, the phrases “at least one of A, B and C,” or “at least one of A, B or C” each refer to only A, only B or only C; any combination of A, B and C; and/or at least one of each of A, B and C.

The predicate words “configured to,” “operable to” and “programmed to” do not imply any particular tangible or intangible modification of a subject, but rather are intended to be used interchangeably. In one or more implementations, a processor configured to monitor and control an operation or a component, may also mean the processor being programmed to monitor and control the operation or the processor, being operable to monitor and control the operation. Likewise, a processor configured to execute code can be construed as a processor programmed to execute code or operable to execute code.

Phrases such as “an aspect,” “the aspect,” “another aspect,” “some aspects,” “one or more aspects,” “an implementation,” “the implementation,” “another implementation,” “some implementations,” “one or more implementations,” “an embodiment,” “the embodiment,” “another embodiment,” “a configuration,” “the configuration,” “another configuration,” “some configurations,” “one or more configurations,” “the subject technology,” “the disclosure,” “the present disclosure” or any other variations thereof and alike are for convenience and do not imply that a disclosure relating to such phrase(s) is essential to the subject technology or that such disclosure applies to all configurations of the subject technology. A disclosure relating to such phrase(s) may apply to all configurations or to one or more configurations. A disclosure relating to such phrase(s) may provide one or more examples. A phrase such as “an aspect” or “some aspects,” may refer to one or more aspects and vice versa and this applies similarly to other foregoing phrases.

The word “exemplary” is used herein to mean “serving as an example, instance or illustration.” Any embodiment described herein as “exemplary” or as an “example” is not necessarily to be construed as preferred or advantageous over other implementations. Furthermore, to the extent that the terms “include,” “have” or the like are used in the description or the claims, such terms are intended to be inclusive in a manner similar to the term “comprise,” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public, regardless of whether such disclosure is explicitly recited in the claims. No claim element is to be construed under the provisions of 35 U.S.C. § 112(f) unless the element is expressly recited using the phrase, “means for,” or, in the case of a method claim, the element is recited using the phrase, “step for.”

The previous description is provided to enable any person skilled in the art to practice the various aspects described herein. Various modifications to these aspects will be readily apparent to those skilled in the art and the generic principles defined herein may be applied to other aspects. Thus, the claims are not intended to be limited to the aspects shown herein, but are to be accorded the full scope consistent with the language claims, wherein reference to an element in the singular is not intended to mean, “one and only one,” unless specifically so stated, but rather, “one or more.” Unless specifically stated otherwise, the term “some” refers to one or more. Pronouns in the masculine (e.g., his) include the feminine and neutral genders (e.g., her and its) and vice versa. Headings and subheadings, if any, are used for convenience only and do not limit the subject disclosure.

What is claimed is:

1. An apparatus, comprising:
a membrane;
a first circuit including a plurality of resistive elements disposed on the membrane and configured to measure a pressure difference, the first circuit having a resistance; and
a second circuit configured to implement a temperature-calibration procedure,
wherein the second circuit is configured to utilize the resistance to measure a temperature used in the temperature-calibration procedure.

2. The apparatus of claim 1, wherein the first circuit comprises a Wheatstone bridge, and wherein the resistance of the first circuit comprises a Wheatstone bridge resistance measured at an output port of the Wheatstone bridge.

3. The apparatus of claim 2, wherein the Wheatstone bridge resistance is configured to be independent of a strain caused by the pressure difference.

4. The apparatus of claim 1, wherein the second circuit is configured to use the temperature-calibration procedure to allow measuring the pressure difference independent of a temperature change.

5. The apparatus of claim 1, wherein the plurality of resistive elements are made of a semiconductor material, and wherein a doping level of the semiconductor material is used to adjust a temperature dependence of the resistance of the first circuit.

6. The apparatus of claim 1, further comprising a third circuit configured to enable the plurality of resistive elements to heat up the membrane.

7. The apparatus of claim 6, wherein the third circuit is configured to change a level of a current applied to the first circuit to cause a temperature change of the plurality of resistive elements.

8. The apparatus of claim 6, wherein the membrane is disposed over a cavity, and wherein the membrane comprises a semiconductor material including silicon.

9. The apparatus of claim 8, wherein the second circuit is configured to implement the temperature-calibration procedure.

10. The apparatus of claim 8, wherein the second circuit is configured to implement the temperature-calibration procedure by:
measuring a Wheatstone bridge resistance at an output port of a Wheatstone bridge of the first circuit; and
simultaneously using the third circuit to vary a temperature of the membrane.

11. A device, comprising:
a first circuit including a plurality of elements, having a resistance and configured to measure a pressure difference;
a second circuit configured to implement a temperature-calibration procedure by utilizing the resistance to measure a temperature of the first circuit;
a third circuit configured to heat up the first circuit; and
a fourth circuit configured to determine an applied stress by measuring a bridge voltage across two terminals of the first circuit,
wherein the resistance is independent of a strain causing the pressure difference.

12. The device of claim 11, wherein the first circuit comprises a Wheatstone bridge, and wherein the resistance is measured at an output port of the Wheatstone bridge.

13. The device of claim 11, wherein the third circuit is configured to allow for a temperature calibration, enabling the pressure difference to be measured independent of a temperature change.

14. The device of claim 11, wherein the plurality of elements comprise resistive elements made of a semiconductor material, and wherein a doping level of the semiconductor material is used to adjust a temperature dependence of the resistance.

15. The device of claim 11, wherein the first circuit is disposed on a membrane, wherein the membrane comprises a semiconductor material including silicon disposed over a cavity.

16. The device of claim 15, wherein the third circuit is configured to implement the temperature-calibration procedure.

17. The device of claim 16, wherein the third circuit is configured to implement the temperature-calibration procedure by providing a heating current to the first circuit by using the second circuit to simultaneously measure the resistance and a voltage of the first circuit.

18. A mobile communication device, comprising:
a transducer comprising:
a membrane disposed over a cavity;
a first circuit including a plurality of elements having a resistance, the first circuit being disposed on the membrane and configured to measure a pressure difference; and
a second circuit configured to implement a temperature-calibration procedure by utilizing the resistance of the first circuit to measure a temperature used in the temperature-calibration procedure.

19. The mobile communication device of claim 18, wherein the plurality of elements comprises resistive elements of a Wheatstone bridge and the resistance is measured at an output port of the Wheatstone bridge.

20. The mobile communication device of claim 19, further comprising a third circuit configured to heat up the membrane and a fourth circuit configured to determine an applied stress by measuring a bridge voltage across two terminals of the first circuit, and wherein the second circuit is configured to implement the temperature-calibration procedure of the membrane by using the third circuit to vary a temperature of the membrane at a predetermined pressure and simultaneously measuring the resistance and the bridge voltage of the first circuit.
